(19) United States
(12) Patent Application Publication
(10) Pub. No.: US 2012/0167103 A1
(43) Pub. Date: Jun. 28, 2012

(54) APPARATUS FOR PARALLEL PROCESSING CONTINUOUS PROCESSING TASK IN DISTRIBUTED DATA STREAM PROCESSING SYSTEM AND METHOD THEREOF

(75) Inventors: Dong Oh KIM, Seoul (KR); Mi Young LEE, Daejeon (KR)

(73) Assignee: Electronics and Telecommunications Research Institute, Daejeon (KR)

(21) Appl. No.: 13/329,610

(22) Filed: Dec. 19, 2011

(30) Foreign Application Priority Data
Dec. 23, 2010 (KR) 10-2010-0134090

(51) Int. Cl. G06F 9/46

(52) U.S. Cl. 718/102

(57) ABSTRACT

Disclosed are an apparatus and a method for parallel processing continuous processing tasks in a distributed data stream processing system. A system for processing a distributed data stream according to an exemplary embodiment of the present invention includes a control node configured to determine whether a parallel processing of continuous processing tasks for an input data stream is required and if the parallel processing is required, instruct to divide the data stream and allocate the continuous processing tasks for processing the data streams to a plurality of distributed processing nodes, and a plurality of distributed processing nodes configured to divide the input data streams, allocate the divided data stream and the continuous processing tasks for processing the divided data streams, respectively, and combine the processing results, according to the instruction of the control node.

### CROSS-REFERENCE TO RELATED APPLICATIONS

This application claims priority to and the benefit of Korean Patent Application No. 10-2010-0134090 filed in the Korean Intellectual Property Office on Dec. 23, 2010, the entire contents of which are incorporated herein by reference.

### TECHNICAL FIELD

The present invention relates to a distributed data stream processing system, and more specifically, to an apparatus and a method for parallel processing a continuous processing task in a distributed data stream processing system that is capable of efficiently parallel processing by after determining the necessity of parallel processing of a data stream, dividing data streams according to the determination result and allocating the divided data streams into plural continuous processing tasks.

### BACKGROUND ART

A data stream processing system for processing a continuous query under a data stream environment in which new data is rapidly, continuously, and infinitely generated, has been developed. In the data stream processing system, the query is formed of plural continuous processing tasks (operations) for processing the data streams. The data stream processing system should process data in which these continuous processing tasks are rapidly and continuously input. For this purpose, these continuous processing tasks process the data in a specific unit (window).

Further, it has been developed a distributed data stream processing system that is capable of distributing and processing continuous queries using a plurality of nodes in order to process the data stream, which is non-periodically and sharply increased. The distributed data stream processing system distributes and processes the plural continuous processing tasks that form the query using one or more nodes for processing continuous queries for the data stream.

FIG. 1 is a diagram illustrating an operation principle of a distributed data processing system according to the related art.

As shown in FIG. 1, the continuous processing tasks that form the continuous queries in the distributed data processing system according to the related art are distributed into a plurality of nodes and then processed.

However, since the input data stream in the distributed data stream processing system is sharply increased, a specific task cannot be processed in the single node. Therefore, continuous query processing may be delayed, and a stop or an error of the distributed data stream processing system may occur.

In order to solve the above problem, the distributed data stream processing system according to the related art uses a load shedding method that selectively discards the data stream. However, this method also has a problem of lowering precision of a processing result.

### SUMMARY OF THE INVENTION

The present invention has been made in an effort to provide an apparatus and a method for parallel processing continuous processing tasks in a distributed data stream processing system that is capable of parallel processing the continuous processing task by dividing the data stream and processing the divided data stream in the continuous processing task allocated to the plurality of nodes, after determining whether parallel processing of continuous processing tasks for processing the data stream is required if it is determined that the parallel processing is required.

An exemplary embodiment of the present invention provides a system for processing a distributed data stream, including: a control node configured to determine whether a parallel processing of continuous processing tasks for an input data stream is required and if the parallel processing is required, instruct to divide the data stream and allocate the continuous processing tasks for processing the data streams to a plurality of distributed processing nodes; and a plurality of distributed processing nodes configured to divide the input data streams, allocate the divided data stream and the continuous processing tasks for processing the divided data streams, and combine the processing results, according to the instruction of the control node.

The control node may compares a cost of processing a specific continuous processing task for a predetermined amount of data stream in a single node with a cost of parallel processing the specific continuous processing task for the predetermined amount of data stream in plural nodes, and determines the necessity of parallel processing of the task according to the comparison result.

The control node may determine that the parallel processing of the continuous processing tasks is required when Equation 1 is satisfied.

$${\sum }_{1}^{W} ( {T}_{1} + {C}_{1} ) > {\sum }_{1}^{W} {T}_{2} + {\sum }_{1}^{W} {C}_{2} + {\sum }_{1}^{W} M \qquad [ Equation 1 ]$$

(in which W refers to an amount of input data stream, T1 refers to a data transmitting cost of a single node, C1 refers to a data processing cost of a single node, T2 refers to a data transmitting cost of plural nodes, C2 refers to a data processing cost in the plural nodes, and M refers a cost for combining the processing results).

Another exemplary embodiment of the present invention provides an apparatus for parallel processing continuous processing tasks, including: a transmitting/receiving unit configured to receive a data stream or transmit a processing result for the data stream; a dividing unit configured to divide the data stream according to whether the parallel processing of the continuous processing tasks for the received data stream is required or not; and a processing unit configured to allocate the divided data stream and the parallel task of the continuous processing tasks for processing the data stream to a plurality of distributed processing nodes.

Whether the parallel processing of the continuous processing tasks is required or not may be determined by comparing a cost of processing a specific continuous processing task for a predetermined amount of data stream in a single node with a cost of parallel processing the specific continuous processing task for the predetermined amount of data stream in plural nodes.

It may be determined that the parallel processing of the continuous processing task is required when Equation 2 is satisfied.

$${\sum }_{1}^{W} ( {T}_{1} + {C}_{1} ) > {\sum }_{1}^{W} {T}_{2} + {\sum }_{1}^{W} {C}_{2} + {\sum }_{1}^{W} M \qquad [ Equation 2 ]$$

(in which W refers to an amount of input data stream, T1 refers to a data transmitting cost of a single node, C1 refers to a data processing cost of a single node, T2 refers to a data transmitting cost of plural nodes, C2 refers to a data processing cost in the plural nodes, and M refers a cost for combining the processing results).

The dividing unit may divide the data stream on the basis of a record, which is a minimum unit of a data stream, or a window, which is a basic unit of a continuous processing task processing.

The dividing unit may divide the data streams after combining the data stream input from a plurality of input sources or divides the input data streams, respectively.

The processing unit may deliver the divided data streams to the parallel tasks of the respective distributed processing nodes after previously distributing the parallel tasks of the continuous processing tasks into the plurality of distributed processing nodes, or arrange the parallel tasks of the continuous processing tasks into the respective distributed processing nodes after distributing and storing the divided data streams in the plurality of distributed processing nodes.

The processing unit may allocate the data streams to the continuous processing tasks in the order of input, or regardless of the order of input.

The apparatus may further include a combining unit configured to receive the parallel processing result of the continuous processing tasks from the plurality of distributed processing nodes to deliver the received parallel processing result of the continuous processing tasks to a user or as an input of a next continuous processing task.

Yet another exemplary embodiment of the present invention provides a method for parallel processing continuous processing tasks, including: determining whether a parallel processing of continuous processing tasks for an input data stream is required; dividing the data stream according to the determination result; and allocating the divided data streams and the parallel tasks of continuous processing tasks for processing the data streams to a plurality of distributed processing nodes, respectively.

The determining may includes comparing a cost of processing a specific continuous processing task for a predetermined amount of data stream in a single node with a cost of parallel processing the specific continuous processing task for the predetermined amount of data stream in plural nodes to determine whether the parallel processing of the continuous processing tasks is required according to the comparison result.

The determining may determine that the parallel processing of the continuous processing tasks is required when Equation 3 is satisfied.

$${\sum }_{1}^{W} ( {T}_{1} + {C}_{1} ) > {\sum }_{1}^{W} {T}_{2} + {\sum }_{1}^{W} {C}_{2} + {\sum }_{1}^{W} M \qquad [ Equation 3 ]$$

(in which W refers to an amount of input data stream, T1 refers to a data transmitting cost of a single node, C1 refers to a data processing cost of a single node, T2 refers to a data transmitting cost of plural nodes, C2 refers to a data processing cost in the plural nodes, and M refers a cost for combining the processing results).

The dividing may include: dividing the data stream on the basis of a record, which is a minimum unit of a data stream, or a window, which is a basic unit of a task processing.

The dividing may include: dividing the data streams after combining the data stream input from a plurality of input sources or dividing the input data streams, respectively.

The processing may include: delivering the divided data streams to the parallel tasks of the respective distributed processing nodes after previously distributing the parallel tasks of the continuous processing tasks into the plurality of distributed processing nodes, or arranging the parallel tasks of the continuous processing tasks into the respective distributed processing nodes after distributing the divided data streams in the plurality of distributed processing nodes.

The processing may deliver the data streams into the parallel tasks in the order of input, or regardless of the order of input.

According to exemplary embodiments of the present invention, after determining whether the parallel processing of the continuous processing tasks for processing the data stream is required, the data stream is divided according to the determination result and the continuous processing task for processing the divided data stream is allocated to the plurality of nodes. Therefore, it is possible to distribute the loads that are concentrated on a specific task due to the large data and the overloaded query.

Further, according to the exemplary embodiments of the present invention, since the loads that are concentrated on a specific node are distributed by allocating the continuous processing tasks for processing the data stream to the plurality of nodes, it is possible to guarantee real-time processing of the data stream and reduce the loss of the data stream due to the load shedding.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a diagram illustrating an operation principle of a distributed data processing system according to the related art.

FIG. 2 is a diagram illustrating a distributed data stream processing system according to an exemplary embodiment of the present invention.

FIG. 3 is a diagram illustrating a detailed configuration of a distributed processing node 200 shown in FIG. 2.

FIG. 4 is a diagram illustrating a principle of dividing a data stream according to an exemplary embodiment of the present invention.

FIG. 5 is a diagram illustrating a principle of allocating continuous processing tasks to distributed processing nodes according to an exemplary embodiment of the present invention.

FIG. 6 is a diagram illustrating a principle of delivering the data stream to a continuous processing task according to an exemplary embodiment of the present invention.

FIG. 7 is a diagram illustrating a principle of delivering a parallel processing result of a continuous processing task according to an exemplary embodiment of the present invention.

FIG. 8 is a diagram showing a method of parallel processing a continuous processing task according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment. Further, in the description of this invention, if it is determined that the detailed description of the configuration or function of the related art may unnecessarily deviate from the gist of the present invention, the detailed description of the related art will be omitted. Hereinafter, preferred embodiments of this invention will be described. However, the technical idea is not limited thereto, but can be modified or performed by those skilled in the art.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings. First of all, we should note that in giving reference numerals to elements of each drawing, like reference numerals refer to like elements even though like elements are shown in different drawings. In describing the present invention, well-known functions or constructions will not be described in detail since they may unnecessarily obscure the understanding of the present invention. It should be understood that although exemplary embodiment of the present invention are described hereafter, the spirit of the present invention is not limited thereto and may be changed and modified in various ways by those skilled in the art.

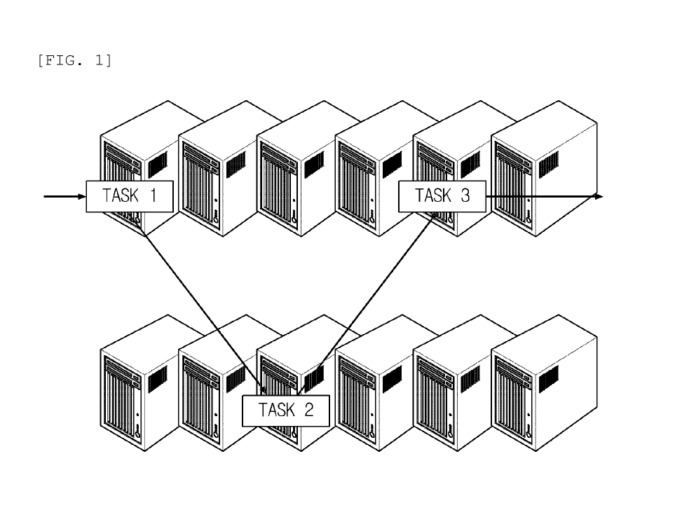

Hereinafter, an apparatus and a method for parallel processing continuous processing tasks in a distributed data stream processing system according to an exemplary embodiment of the present invention will be described in detail with reference to FIGS. 1 to 8.

Specifically, the exemplary embodiment of the present invention suggests that after determining whether the parallel processing of the continuous processing tasks for processing the data stream is required, if it is determined that the parallel processing is required, the data stream is divided and the continuous processing tasks for processing the divided data streams are allocated to a plurality of nodes to parallel process the continuous processing tasks without excessively allocating the task to a specific node.

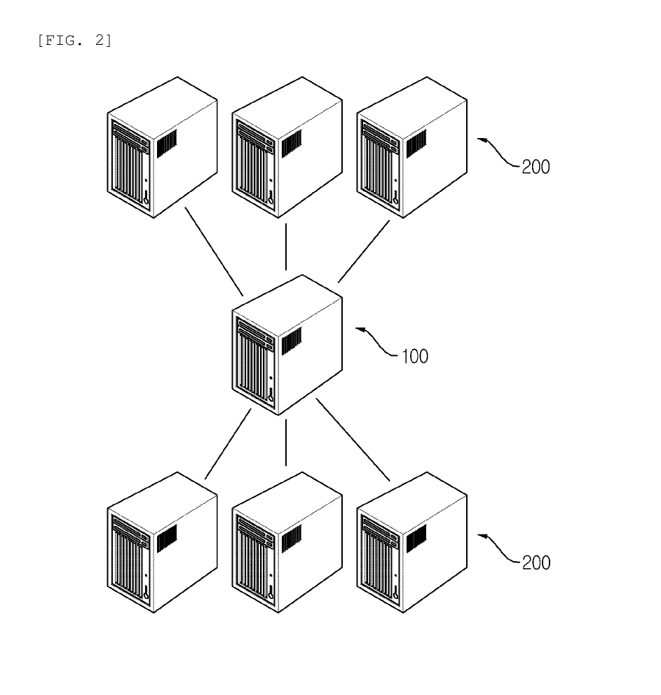

FIG. 2 is a diagram illustrating a distributed data stream processing system according to an exemplary embodiment of the present invention.

As shown in FIG. 2, a distributed data stream processing system according to an exemplary embodiment of the present invention includes a control node 100 and a plurality of distributed processing nodes 200.

The control node 100 is a node for controlling the processing of a large data stream. The control node 100 determines the necessity of the parallel processing of the continuous processing task for the data stream and instructs the parallel processing.

Specifically, the control node 100 determines whether the parallel processing of the continuous processing tasks for the input data stream is required. If it is determined that the parallel processing is required, the control node 100 instructs the plurality of distributed processing nodes to divide the data streams and allocate the continuous processing task for processing the divided data stream to the plurality of distributed processing nodes.

In this case, the exemplary embodiment of the invention does not perform parallel processing of the continuous processing tasks for all data stream, but performs parallel processing of the continuous processing task for a data stream only in the event of processing the large data stream, which can reduce the continuous query processing cost by using distributed parallel processing when considering the query processing performance in consideration of the memory overload of the corresponding node or processing delay. Therefore, the distributed data stream processing system needs to determine whether the parallel processing is required, before parallel processing the continuous processing task, which will be described below.

The control node 100 may determine whether the parallel processing of the continuous processing tasks for the data stream is required. The necessity of the parallel processing may be determined by comparing the cost of processing the specific task for a predetermined amount of data W in a single node with the cost of parallel processing the specific task for the predetermined amount of data W in a plurality of nodes.

That is, the control node 100 can determine that the parallel processing is required when the following equation 1 is satisfied.

$${\sum }_{1}^{W} ( {T}_{1} + {C}_{1} ) > {\sum }_{1}^{W} {T}_{2} + {\sum }_{1}^{W} {C}_{2} + {\sum }_{1}^{W} M \qquad [ Equation 1 ]$$

Here, the left side represents the sum of processing costs in the single node, wherein T1 refers to a data transmitting cost of the single node, and C1 refers to a data processing cost of the single node. In this case, C1 may, include all costs that are consumed due to the memory overload and the processing delay caused by the processing in the single node. The right side represents the sum of processing costs in the plural nodes, wherein T2 refers to the data transmitting cost of the plural nodes, C2 refers to a data processing cost in the plural nodes, and M refers a cost for combining the processing results.

If Equation 1 is satisfied, the control node 100 may determine that the parallel processing of the continuous processing task for the data stream is required when the cost of processing the specific continuous processing task of a predetermined amount of data W in a single node is higher than the cost of parallel processing the specific continuous processing task of the predetermined amount of data W in a plurality of nodes.

In this case, since the operation cost required to determine whether the parallel processing needs to be continued may be large, a portion of scheduling and optimizing the distributed data stream processing system periodically determines, and the parallel processing needs to be performed until it is determined that no more parallel processing is required.

According to the instruction of the control node 100, the distributed processing node 200 divides the data stream, allocates and processes the continuous processing tasks, and combines the processed results and delivers the combined results. Specifically, according to the instruction of the control node 100, the role of dividing the data stream or allocating the continuous processing task for processing the divided data stream to the plurality of distributed processing nodes may be processed or performed by different distributed processing nodes 200.

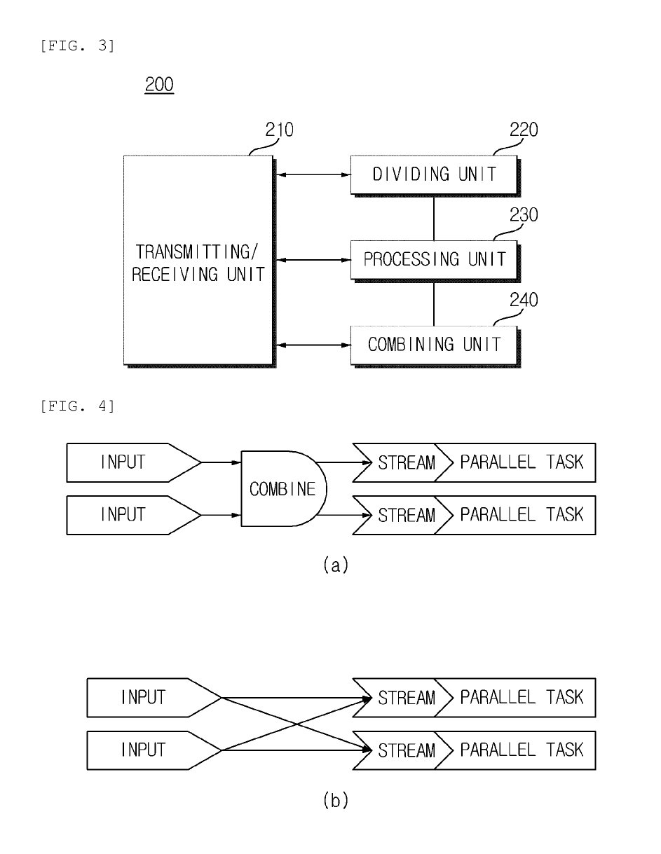

FIG. 3 is a diagram illustrating a detailed configuration of a distributed processing node 200 shown in FIG. 2.

As shown in FIG. 3, the distributed processing node 200 according to an exemplary embodiment of the present invention includes a transmitting/receiving unit 210, a dividing unit 220, a processing unit 230, and a combining unit 240.

The transmitting/receiving unit 210 receives the data stream or transmits the processing result for the data stream.

The dividing unit 220 divides the data stream if it is determined that the parallel processing of the continuous processing tasks for the data stream is required. Here, the data stream may be divided on the basis of a record, which is a minimum unit of a data stream or a window, which is a basic unit of a continuous processing task processing.

When the record is used as a basis, the continuous processing tasks should be processed in the unit of record.

In this case, there may be not only several inputs of continuous processing task but also several input sources of a data stream. Therefore, the dividing unit 220 divides the data stream using several methods, which will be described with reference to FIG. 4.

FIG. 4 is a diagram illustrating a principle of dividing a data stream according to an exemplary embodiment of the present invention.

As shown in FIG. 4, FIG. 4(a) shows a method of dividing the data stream after combining the data streams input from two input sources. This method needs a separate process to combine the data stream, but divides the data stream only once.

In contrast, FIG. 4(b) shows a method of dividing data streams input from two input sources, respectively. According to this method, as the number of input sources increases, a network channel for delivering correspondingly increases. However, this method can be simply embodied.

Therefore, if the number of input sources is small, the method of dividing the data stream after combining the data stream as shown in FIG. 4(a) is more advantageous. However, the method of dividing the data stream is preferably set considering the input source and the network traffic.

The processing unit 230 allocates the continuous processing tasks for processing the divided data stream to the plurality of distributed processing nodes. In this case, the processing unit 230 arranges the continuous processing tasks for processing the data stream into the plurality of distributed processing nodes and then delivers the divided data streams to the respective continuous processing tasks. In another example, the processing unit 230 stores the data stream in a specific distributed processing node and then allocates the continuous processing tasks for processing the corresponding data stream to the corresponding distributed processing node.

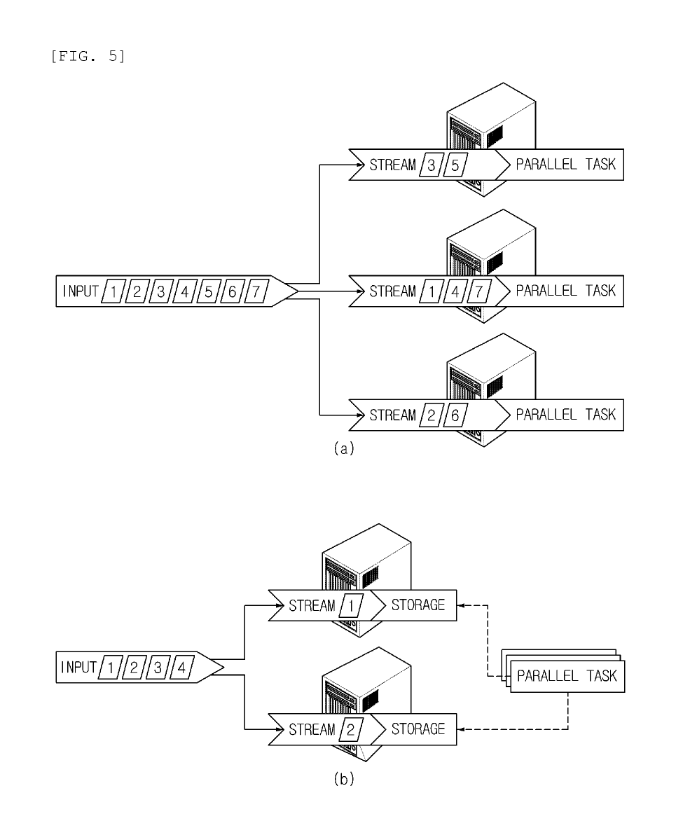

FIG. 5 is a diagram illustrating a principle of allocating a continuous processing task to distributed processing nodes according to an exemplary embodiment of the present invention.

As shown in FIG. 5, FIG. 5(a) shows a method of allocating the divided data stream to the continuous processing tasks of the respective distributed processing nodes after distributing the continuous processing tasks into the plurality of distributed processing nodes in advance.

In contrast, FIG. 5(b) shows a method of arranging the continuous processing tasks into the respective distributed processing nodes after allocating the data stream to the plurality of distributed processing nodes. The method shown in FIG. 5(b) needs to consider a portion of storing the divided data stream before arranging the continuous processing tasks and then arranging the continuous processing tasks. However, the method of FIG. 5(b) has better expandability and higher resource activity of a node than the method of FIG. 5(a).

However, the method of FIG. 5(a) can be simply implemented and has a higher processing speed, as compared with the method of FIG. 5(b).

Therefore, it is preferable that a method of allocating a continuous processing task for processing divided data streams to a plurality of distributed processing nodes is set considering the resource utilizability and processing speed.

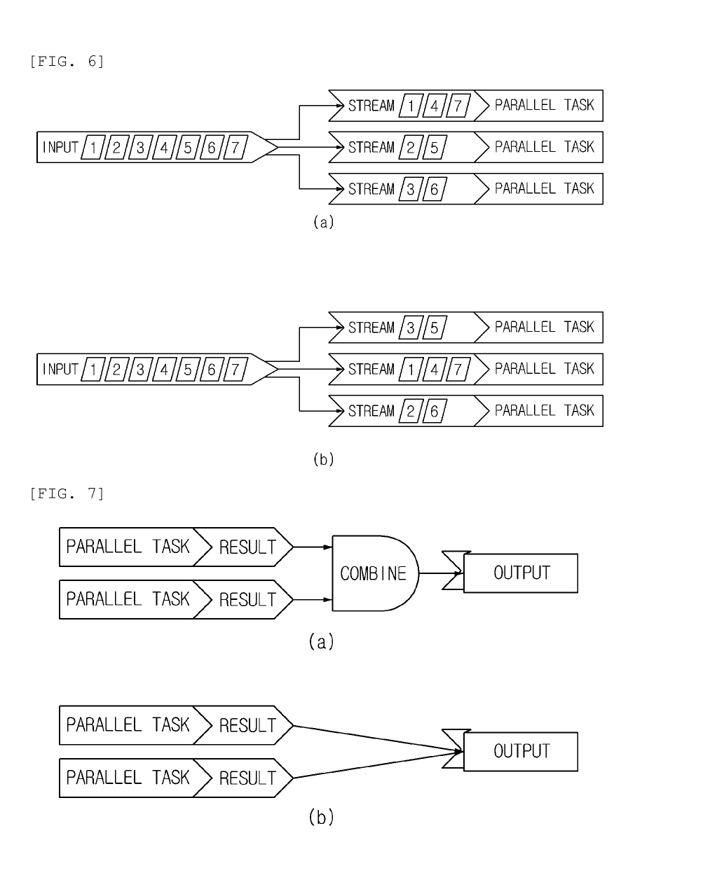

FIG. 6 is a diagram illustrating a principle of delivering the data stream to a continuous processing task according to an exemplary embodiment of the present invention.

As shown in FIG. 6, FIG. 6(a) shows a method of delivering the data streams to the parallel tasks in the order of input, and for example, shows that a first data stream 1 to a last data stream 7 are allocated to three parallel tasks in order.

In contrast, FIG. 6(b) shows a method of delivering the data streams to the parallel tasks regardless of the input order of the data streams, and for example, the first data stream 1 to the last data stream 7 are allocated to the three parallel tasks regardless the order of being input to the parallel task.

The combining unit 240 combines the parallel processing results upon receiving the parallel processing results of the continuous processing tasks from the plurality of distributed processing nodes and then delivers the parallel processing results of the continuous processing task to a user or as an input of a next task.

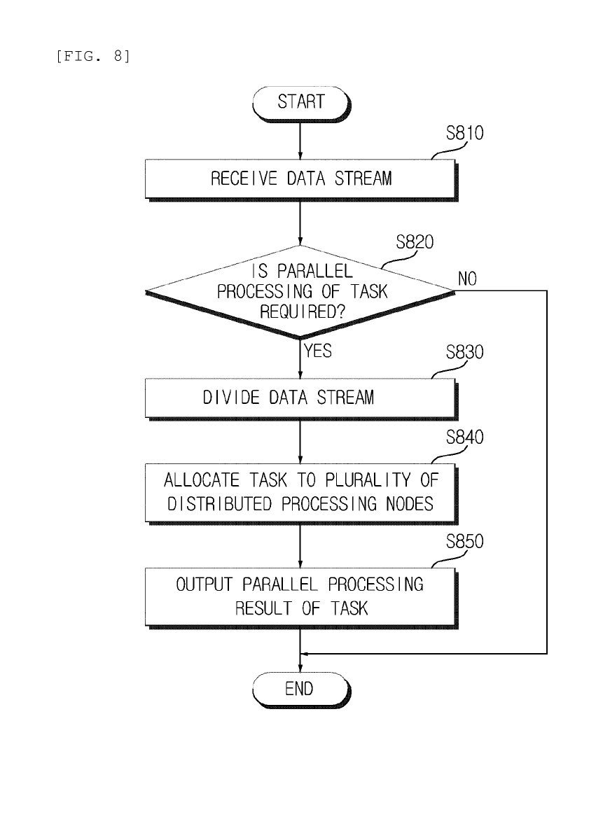

FIG. 7 is a diagram illustrating a principle of delivering a parallel processing result of a task according to an exemplary embodiment of the present invention.

As shown in FIG. 7, FIG. 7(a) shows a method of receiving the parallel processing results of the continuous processing task from the plurality of distributed processing nodes, combining the received parallel processing results of the continuous processing tasks, and then transmitting the results to an output.

In this case, if the parallel processing results of the continuous processing task need to be reconstructed in the order of input regardless of the order of receiving the processing results in the parallel tasks from the plurality of distributed processing nodes, the reconstruction needs to be processed. That is, the output needs to be reconstructed considering the data stream dividing method.

In contrast, FIG. 7(b) shows a method of receiving the parallel processing results of the tasks from the plurality of distributed processing nodes and outputting the received parallel processing result of the continuous processing task as received. According to this method, the parallel processing results of the continuous processing tasks should be combined at an output unit.

FIG. 8 is a diagram showing a method of parallel processing a task according to an exemplary embodiment of the present invention.

As shown in FIG. 8, if a large quantity of data streams is input to the distributed processing nodes (S810), the control node according to an exemplary embodiment of the invention determines whether the parallel processing of the continuous processing tasks for the input data streams is required (S820). That is, the control nodes compares the cost of processing a specific task of a predetermined amount of data streams in a single node with the cost of processing the specific task of the predetermined amount of data streams in plural nodes and determines the necessity of the parallel processing of the continuous processing tasks according to the comparison result.

Next, if it is determined that the parallel processing of the continuous processing tasks for the input data streams is required according to the determination result, the control node may instruct to perform parallel processing by dividing the data stream. In contrast, if it is determined that the parallel processing of the continuous processing tasks for the input data streams is not required according to the determination result, the control node may instruct to process as processed in the existing method.

In this case, the distributed processing node divides the data streams according to the instruction of the control node (S830). The data streams input from a plurality of input sources may be combined and then divided or the data streams input from the plurality of input sources may be divided respectively.

Next, the distributed processing node allocates the parallel tasks for processing the divided data streams to the plurality of distributed processing nodes (S840).

In this case, the distributed processing node distributes and arranges the parallel tasks into the plurality of distributed processing nodes in advance, and then delivers the divided data streams to the tasks of the respective distributed processing nodes. Otherwise, the distributed processing node stores the divided data streams in the plurality of distributed processing nodes in distributed manner, and then arranges the tasks to the respective distributed processing nodes.

The distributed processing nodes allocate the divided data streams to the continuous processing tasks in the order of input or allocate the divided data streams to the tasks regardless of the input order.

Next, the distributed processing nodes receive the parallel processing result of the task from the plurality of distributed processing nodes and output the received parallel processing result of the task (S850). That is, the distributed processing nodes deliver the parallel processing result of the continuous processing task to the user or as an input of a next continuous processing task.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A system for processing a distributed data stream, comprising:
a control node configured to determine whether a parallel processing of continuous processing tasks for an input data stream is required and if the parallel processing is required, instruct to divide the data stream and allocate the continuous processing tasks for processing the data streams to a plurality of distributed processing nodes; and
a plurality of distributed processing nodes configured to divide the input data streams, allocate the divided data stream and the continuous processing tasks for processing the divided data streams, and combine the processing results, according to the instruction of the control node.

2. The system of claim 1, wherein the control node compares a cost of processing a specific continuous processing task for a predetermined amount of data stream in a single node with a cost of parallel processing the specific continuous processing task for the predetermined amount of data stream in plural nodes, and determines the necessity of parallel processing of the task according to the comparison result.

3. The system of claim 1, wherein the control node determines that the parallel processing of the continuous processing tasks is required when Equation 1 is satisfied.
$${\sum }_{1}^{W} ( {T}_{1} + {C}_{1} ) > {\sum }_{1}^{W} {T}_{2} + {\sum }_{1}^{W} {C}_{2} + {\sum }_{1}^{W} M \qquad [ Equation 1 ]$$
(in which W refers to an amount of input data stream, T1 refers to a data transmitting cost of a single node, C1 refers to a data processing cost of a single node, T2 refers to a data transmitting cost of plural nodes, C2 refers to a data processing cost in the plural nodes, and M refers a cost for combining the processing results).

4. An apparatus for parallel processing continuous processing tasks, comprising:
a transmitting/receiving unit configured to receive a data stream or transmit a processing result for the data stream;
a dividing unit configured to divide the data stream according to whether the parallel processing of the continuous processing tasks for the received data stream is required or not; and
a processing unit configured to allocate the divided data stream and the parallel task of the continuous processing tasks for processing the data stream to a plurality of distributed processing nodes.

5. The apparatus of claim 4, wherein whether the parallel processing of the continuous processing tasks is required or not is determined by comparing a cost of processing a specific continuous processing task for a predetermined amount of data stream in a single node with a cost of parallel processing the specific continuous processing task for the predetermined amount of data stream in plural nodes.

6. The apparatus of claim 4, wherein it is determined that the parallel processing of the continuous processing task is required when Equation 2 is satisfied.
$${\sum }_{1}^{W} ( {T}_{1} + {C}_{1} ) > {\sum }_{1}^{W} {T}_{2} + {\sum }_{1}^{W} {C}_{2} + {\sum }_{1}^{W} M \qquad [ Equation 2 ]$$
(in which W refers to an amount of input data stream, T1 refers to a data transmitting cost of a single node, C1 refers to a data processing cost of a single node, T2 refers to a data transmitting cost of plural nodes, C2 refers to a data processing cost in the plural nodes, and M refers a cost for combining the processing results).

7. The apparatus of claim 4, wherein the dividing unit divides the data stream on the basis of a record, which is a minimum unit of a data stream, or a window, which is a basic unit of a continuous processing task processing.

8. The apparatus of claim 4, wherein the dividing unit divides the data streams after combining the data stream input from a plurality of input sources or divides the input data streams, respectively.

9. The apparatus of claim 4, wherein the processing unit delivers the divided data streams to the parallel tasks of the respective distributed processing nodes after previously distributing the parallel tasks of the continuous processing tasks into the plurality of distributed processing nodes, or
arranges the parallel tasks of the continuous processing tasks into the respective distributed processing nodes after distributing and storing the divided data streams in the plurality of distributed processing nodes.

10. The apparatus of claim 9, wherein the processing unit allocates the data streams to the continuous processing tasks in the order of input, or regardless of the order of input.

11. The apparatus of claim 4, further comprising:
a combining unit configured to receive the parallel processing result of the continuous processing tasks from the plurality of distributed processing nodes to deliver the received parallel processing result of the continuous processing tasks to a user or as an input of a next continuous processing task.

12. A method for parallel processing continuous processing tasks, comprising:
determining whether a parallel processing of continuous processing tasks for an input data stream is required;
dividing the data stream according to the determination result; and
allocating the divided data streams and the parallel tasks of continuous processing tasks for processing the data streams to a plurality of distributed processing nodes, respectively.

13. The method of claim 12, wherein the determining includes comparing a cost of processing a specific continuous processing task for a predetermined amount of data stream in a single node with a cost of parallel processing the specific continuous processing task for the predetermined amount of data stream in plural nodes to determine whether the parallel processing of the continuous processing tasks is required according to the comparison result.

14. The method of claim 12, wherein the determining determines that the parallel processing of the continuous processing tasks is required when Equation 3 is satisfied.
$${\sum }_{1}^{W} ( {T}_{1} + {C}_{1} ) > {\sum }_{1}^{W} {T}_{2} + {\sum }_{1}^{W} {C}_{2} + {\sum }_{1}^{W} M \qquad [ Equation 3 ]$$
(in which W refers to an amount of input data stream, T1 refers to a data transmitting cost of a single node, C1 refers to a data processing cost of a single node, T2 refers to a data transmitting cost of plural nodes, C2 refers to a data processing cost in the plural nodes, and M refers a cost for combining the processing results).

15. The method of claim 12, wherein the dividing includes:
dividing the data stream on the basis of a record, which is a minimum unit of a data stream, or a window, which is a basic unit of a task processing.

16. The method of claim 12, wherein the dividing includes:
dividing the data streams after combining the data stream input from a plurality of input sources or dividing the input data streams, respectively.

17. The method of claim 12, wherein the processing includes:
delivering the divided data streams to the parallel tasks of the respective distributed processing nodes after previously distributing the parallel tasks of the continuous processing tasks into the plurality of distributed processing nodes, or
arranging the parallel tasks of the continuous processing tasks into the respective distributed processing nodes after distributing the divided data streams in the plurality of distributed processing nodes.

18. The method of claim 17, wherein the processing delivers the data streams into the parallel tasks in the order of input, or regardless of the order of input.
